(19) United States
(12) Patent Application Publication
(10) Pub. No.: US 2009/0111501 A1
(43) Pub. Date: Apr. 30, 2009

(54) WIRELESS COMMUNICATION SYSTEM AND ITS DEVICE

(76) Inventors: Min-Tsung TANG, Taoyuan Hsien (TW); Chih-Hung Chiu, Taoyuan Hsien (TW); Chi-Liang Lin, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,925

(22) Filed: Feb. 7, 2008

(30) Foreign Application Priority Data
Oct. 26, 2007 (TW) 096140393

(51) Int. Cl. H04B 7/00; H04M 1/00

(52) U.S. Cl. 455/522; 455/573

(57) ABSTRACT

A wireless communication device includes a wireless communication module and a solar power module electrically connected with the wireless communication module. The wireless communication module transmits or receives a first wireless communication signal. The solar power module receives a light and outputs a power to the wireless communication module according to the light. A wireless communication system is also disclosed.

### CROSS REFERENCE TO RELATED APPLICATIONS

This Non-provisional application claims priority under 35 U.S.C. §119(a) on Patent Application No(s). 096140393 filed in Taiwan, Republic of China on Oct. 26, 2007, the entire contents of which are hereby incorporated by reference.

### BACKGROUND OF THE INVENTION

1. Field of Invention

The present invention relates to a communication system and, in particular, to a wireless communication system and its device.

2. Related Art

At present, sensing devices have been widely used in industries. For example, a temperature sensing device is utilized to monitor an environmental temperature, a humidity sensing device is utilized to monitor an environmental humidity and an optical sensing device is utilized to monitor an environmental brightness. Arranging the sensing devices at different positions can construct a sensing system or a monitoring system for monitoring the environment so as to achieve the objects of early problem warning and enhancing the overall efficiency.

In addition, the development of the wireless communication technology has been speeded up due to the progress of the technology. Then, the sensing device has been manufactured to have the wireless function in the industry. That is, a sensing module can be embedded in a wireless communication device or the sensing device can cooperate with the wireless communication device, thereby the wireless control can be performed by integrating the sensing result and the wireless communication.

In general, an electric source of a wireless communication device includes a mains power and a battery. However, when the mains power serves as the electric source, the wireless communication device has to be arranged along the electric power line. Thus, the flexibility of the arranging positions thereof is reduced. If the battery serves as the electric source of the wireless communication device, the electric power of the battery is consumed with time after the wireless communication device is used for a period of time. Therefore, when the battery serves as the electric source of the wireless communication device, the problem that the electric power of the battery is used up still exists, and the battery has to be replaced frequently. Thus, the user may feel inconvenient.

Therefore, it is an important subject to provide a wireless communication device and a wireless communication system, which can be used without worrying about the power supply problem.

### SUMMARY OF THE INVENTION

In view of the foregoing, the present invention is to provide a wireless communication system and its device that can utilize a light as the power supply source.

To achieve the above, the present invention discloses a wireless communication device including a wireless communication module and a solar power module. The wireless communication module transmits or receives a first wireless communication signal. The solar power module is electrically connected to the wireless communication module. The solar power module can receive a light and then output a first power to the wireless communication module according to the light.

In addition, the present invention also discloses a wireless communication system having a plurality of wireless communication devices, which are communicated with each other by wireless communication technology. Each of the wireless communication devices includes a wireless communication module and a solar power module, which are electrically connected to each other. The wireless communication module transmits or receives a first wireless communication signal. The solar power module receives a light and outputs a first power to the wireless communication module according to the light.

As mentioned above, the solar power module receives the light and outputs a power to the wireless communication module according to the light according to the present invention. Therefore, the wireless communication system and its device of the present invention can prevent the application from being restricted by the power socket, and can prevent the inconvenience that the battery has to be replaced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic illustration showing a wireless communication device according to an embodiment of the present invention; and

FIG. 2 is a schematic illustration showing a wireless communication system according to the embodiment of the present invention.

### DETAILED DESCRIPTION OF THE INVENTION

The present invention will be apparent from the following detailed description, which proceeds with reference to the accompanying drawings, wherein the same references relate to the same elements.

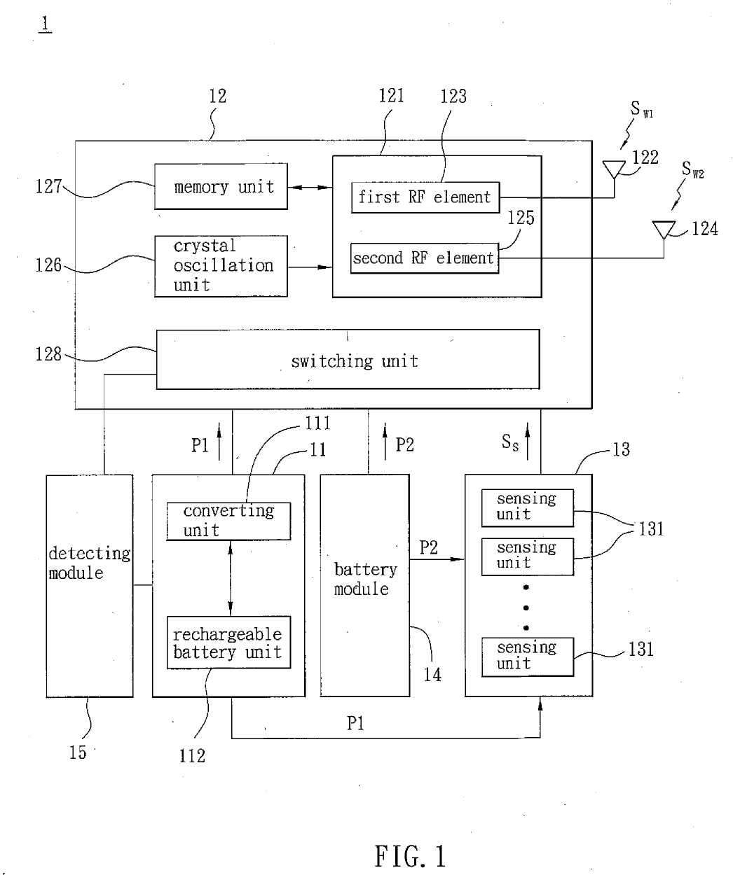

Referring to FIG. 1, a wireless communication device 1 according to an embodiment of the present invention includes a solar power module 11, a wireless communication module 12, a sensing module 13, a battery module 14 and a detecting module 15. The wireless communication module 12, the solar power module 11 and the sensing module 13 are electrically connected to one another, The battery module 14 is electrically connected to the wireless communication module 12 and the sensing module 13.

The solar power module 11 includes a converting unit 111 for receiving a light and converting the light into a first power P1 serving as an electric source of the wireless communication module 12 and the sensing module 13. In this embodiment, the light is a solar light source, for example.

In addition, the solar power module 11 further includes a rechargeable battery unit 112 electrically connected to the converting unit 111. When the converting unit 111 converts the light into the first power P1, a portion of the first power P1 is provided to the wireless communication module 12 and the sensing module 13, and the other portion of the first power P1 is stored to the rechargeable battery unit 112. The rechargeable battery unit 112 may be a rechargeable battery.

When the light is weaker or insufficient and the converting unit 111 cannot generate the sufficient first power P1, the rechargeable battery unit 112 can provide the portion of the first power P1 stored therein to the wireless communication module 12 and thus to continue to provide enough electric power for the wireless communication module 12.

The detecting module 15 is electrically connected to the solar power module 11 and the wireless communication module 12 for detecting the electric capacity of the solar power module 11 and transmitting the electric capacity to the wireless communication module.

As shown in FIG. 1, the wireless communication module 12 further includes a switching unit 128 electrically connected with the solar power module 11 and the battery module 14.

In the embodiment, when the light is weaker or insufficient, the converting unit 111 cannot generate the first power P1. At the mean while, the rechargeable battery unit 112 can provide the portion of the first power P1 stored therein to the wireless communication module 12 so that the detecting module 15 can continuously detect the electric capacity of the solar power module 11 and transmit the electric capacity to the wireless communication module 12.

The switching unit 128 of the wireless communication module 12 switches the solar power module 11 or the battery module 14 to serve as the electric source of the wireless communication module 12 according to the electric capacity.

When the detecting module 15 detects that the electric capacity of the solar power module 11 is smaller than a predefined value, the switching unit 128 switches to provide the electric source from the battery module 14 to the wireless communication module 12. Then, the battery module 14 outputs a second power P2 to the wireless communication module 12 to continue to provide the electric power for the wireless communication module 12. In practice, the battery module 14 can be a carbon-zinc, alkalineery, nickel cadmium, nickel hydrogen or lithium battery.

The sensing module 13 includes at least one sensing unit 131 for outputting a sensed signal S_{S} to the wireless communication module 12. In practice, the sensing unit 131 can be a temperature sensor for monitoring the environment temperature, a humidity sensor for monitoring the environment humidity, or an optical sensor for monitoring the environment brightness. The above-mentioned sensors are disposed at different positions to construct a sensing system or a monitoring system for monitoring the environment and thus for performing the early warning.

With reference to FIG. 1, the wireless communication module 12 includes a main control unit 121 and a first antenna 122 electrically connected with the main control unit 121. In the embodiment, the main control unit 121 can be a central process unit (CPU) or a microcontroller.

The wireless communication module 12 transmits or receives a first wireless communication signal S_{W1} via the first antenna 122. In the embodiment, the main control unit 121 includes a first radio frequency element 123 with a first transmitted power for transmitting/receiving and processing the first wireless communication signal S_{W1}. The wireless communication module 12 further includes a second antenna 124 and a second radio frequency element 125 with a second transmitted power. Therefore, the wireless communication module 12 of this embodiment can also transmit or receive a second wireless communication signal S_{W2} via the second antenna 124. In the embodiment, the second transmitted power is higher than the first transmitted power.

As mentioned above, the first radio frequency element 123 can correspond to a plurality of first antennas 122, and the second radio frequency element 125 can correspond to a plurality of second antennas 124. Herein, the arranged aspect of the radio frequency elements and the antennas is not restricted to 1:1.

When wireless communication signals with different powers are transmitted, the user can increase the numbers of radio frequency elements and antennas according to the requirement.

The first antenna 122 and the second antenna 124 can be a build-in antenna or a removable antenna, respectively, and each of the first and second wireless communication signals S_{W1}, S_{W2} can be an electromagnetic signal.

In addition, when the wireless communication module 12 is transmitting the first wireless communication signal S_{W1} and/or the second wireless communication signal S_{W2}, it transmits or receives the first wireless communication signal S_{W1} and/or the second wireless communication signal S_{W2} according to a personal area network (PAN) protocol. The personal area network protocol is a Zigbee wireless local area network protocol and satisfies an IEEE 802.15.4 specification.

In addition, the wireless communication device 1 can operate in the short distance wireless transmission via the first antenna 122 because the high transmission power is not needed. The wireless communication device 1 can operate in the long distance wireless transmission via the second antenna 124 because the higher transmission power is needed.

As shown in FIG. 1, the wireless communication module 12 further includes a crystal oscillation unit 126, which is electrically connected to the main control unit 121, for providing a clock signal to the main control unit 121.

In the embodiment, the wireless communication module 12 further includes a memory unit 127 electrically connected with the main control unit 121 so that the main control unit 121 can store information into the memory unit 127. For example, when the wireless communication module 12 receives the first wireless communication signal S_{W1}, the second wireless communication signal S_{W2} and/or the sensed signal S_{S}, the main control unit 121 can store the information into the memory unit 127. Herein, each of the first wireless communication signal S_{W1} the second wireless communication signal S_{W2} and the sensed signal S_{S} can include measured temperature data, measured humidity data or measured brightness data.

When the wireless communication module 12 wants to transmit the information stored in the memory unit 127, the main control unit 121 reads the information and the information is transmitted to a destination via the first antenna 122 and the first radio frequency element 123 or via the second antenna 124 and the second radio frequency element 125. In practice, the memory unit 127 is a flash memory.

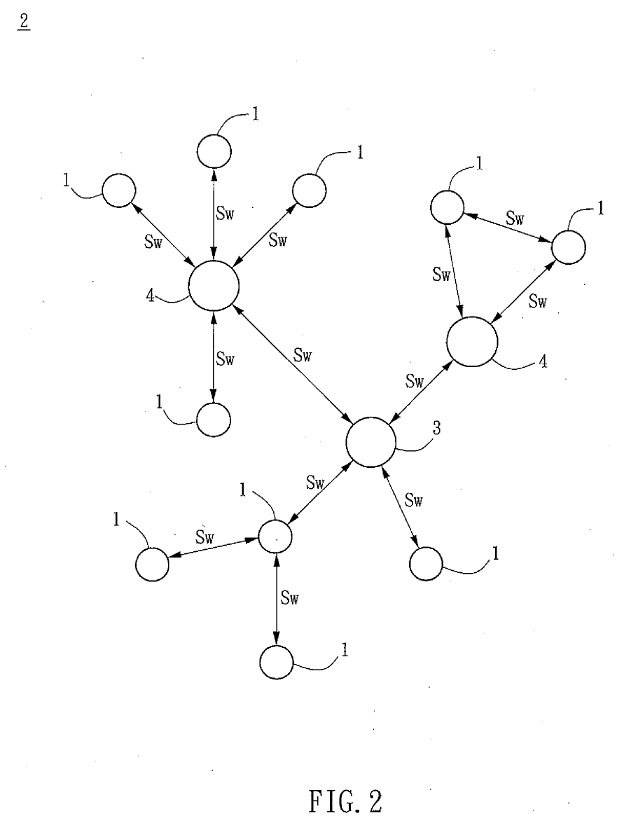

Referring to FIG. 2, a wireless communication system 2 according to the embodiment of the present invention includes a plurality of wireless communication devices 1 for transmitting or receiving at least one wireless communication signal S_{W}. In practice, the wireless communication signal S_{W} includes a first wireless communication signal S_{W1} or a second wireless communication signal S_{W2}. In the embodiment, the wireless communication device 1 can be a fixed device or a mobile device.

In the application of the wireless communication technology, the wireless communication device 1 can be arranged in a star-like topology, a mesh-like topology or a tree-like topology. Taking a mesh-like arrangement as an example, one wireless communication device 1 can be extended up to 65,536 end devices to perform the wireless communication.

As shown in FIG. 2, the wireless communication system 2 further includes a server 3 and a repeater 4. The server 3 and the repeater 4 are electrically connected with at least one wireless communication device 1, and transmit or receive the wireless communication signal S_{W}. Of course, the server 3 and the repeater 4 can transmit the wireless communication signal S_{W} to each other. Because the wireless communication system 2 of this embodiment has the repeater 4, the transmission range of the wireless communication signal S_{W} can be broadened.

In addition, the server 3 and the repeater 4 have a second solar power module (not shown) and a third solar power module (not shown), respectively. The second solar power module and the third solar power module output a third power to the server 3 and output a fourth power to the repeater 4 according to the light, respectively.

In summary, the solar power module receives the light and outputs a power to the wireless communication module according to the light in the wireless communication system and its device according to the present invention. Therefore, the wireless communication system and its device of the present invention can prevent the application from being restricted by the power socket, and can prevent the trouble that the battery has to be replaced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A wireless communication device comprising:
a wireless communication module for transmitting or receiving a first wireless communication signal; and
a solar power module electrically connected to the wireless communication module for receiving a light and outputting a first power to the wireless communication module.

2. The wireless communication device according to claim 1, wherein the solar power module comprises:
a converting unit for converting the light into the first power; and
a rechargeable battery unit electrically connected to the converting unit and storing the first power converted by the converting unit.

3. The wireless communication device according to claim 1, wherein the wireless communication module comprises:
a first antenna for transmitting or receiving the first wireless communication signal;
a second antenna for transmitting or receiving a second wireless communication signal; and
a main control unit electrically connected to the first and second antennas for transmitting or receiving the first wireless communication signal or the second wireless communication signal,
wherein the main control unit comprises a first radio frequency element electrically connected to the first antenna for processing the first wireless communication signal and transmitting or receiving the first wireless communication signal, and a second radio frequency element electrically connected to the second antenna for processing the first wireless communication signal and transmitting or receiving the first wireless communication signal.

4. The wireless communication device according to claim 3, wherein the wireless communication module comprises:
a crystal oscillation unit electrically connected to the main control unit for providing a clock signal; and
a memory unit electrically connected with the main control unit.

5. The wireless communication device according to claim 4, wherein the main control unit is a central process unit (CPU) or a microcontroller, the first and second antennas are build-in antennas or removable antennas, and the memory unit is a flash memory.

6. The wireless communication device according to claim 3, wherein the first radio frequency element has a first transmitted power, and the second radio frequency element has a second transmitted power greater than the first transmitted power.

7. The wireless communication device according to claim 3, wherein the wireless communication module transmits or receives the first and second wireless communication signals according to a personal area network protocol, and the first wireless communication signal or the second wireless communication signal is an electromagnetic signal.

8. The wireless communication device according to claim 1, further comprising a sensing module electrically connected to the wireless communication module and the solar power module, and transmitting a sensed signal to the wireless communication module, wherein the sensing module comprises at least one sensing unit, and the sensing unit is a temperature sensor, a humidity sensor or an optical sensor.

9. The wireless communication device according to claim 1, further comprising a battery module electrically connected to the wireless communication module and outputting a second power to the wireless communication module, wherein the battery module comprises a carbon-zinc battery, an alkaline battery, a nickel cadmium battery, a nickel hydrogen battery or a lithium battery.

10. The wireless communication device according to claim 9, further comprising a detecting module electrically connected to the solar power module and the wireless communication module for detecting an electric capacity of the solar power module and transmitting the electric capacity to the wireless communication module.

11. The wireless communication device according to claim 10, wherein the wireless communication module comprises a switching unit electrically connected to the solar power module and the battery module, and switching to supply the second power outputted from the battery module to the wireless communication module when the detected electric capacity from the detecting module is smaller than a predefined value.

12. A wireless communication system having a plurality of wireless communication devices, wherein the wireless communication device comprises:
a wireless communication module for transmitting or receiving a first wireless communication signal; and
a first solar power module electrically connected to the wireless communication module for receiving a light and outputting a first power to the wireless communication module.

13. The wireless communication system according to claim 12, wherein the first solar power module comprises:
a converting unit for converting the light into the first power; and
a rechargeable battery unit electrically connected to the converting unit and storing the first power converted by the converting unit.

14. The wireless communication system according to claim 12, wherein the wireless communication module comprises:
a first antenna for transmitting or receiving the first wireless communication signal;
a second antenna for transmitting or receiving a second wireless communication signal; and
a main control unit electrically connected to the first and second antennas for transmitting or receiving the first wireless communication signal or the second wireless communication signal,
wherein the main control unit comprises a first radio frequency element electrically connected to the first antenna for processing the first wireless communication signal and transmitting or receiving the first wireless communication signal, and a second radio frequency element electrically connected to the second antenna for processing the first wireless communication signal and transmitting or receiving the first wireless communication signal.

15. The wireless communication system according to claim 14, wherein the wireless communication module comprises:
a crystal oscillation unit electrically connected to the main control unit for providing a clock signal; and
a memory unit electrically connected with the main control unit.

16. The wireless communication system according to claim 14, wherein the wireless communication module transmits or receives the first and second wireless communication signals according to a personal area network protocol, and the first wireless communication signal or the second wireless communication signal is an electromagnetic signal.

17. The wireless communication system according to claim 12, further comprising a sensing module electrically connected to the wireless communication module and the first solar power module, and transmitting a sensed signal to the wireless communication module, wherein the sensing module comprises at least one sensing unit and the sensing unit is a temperature sensor, a humidity sensor or an optical sensor.

18. The wireless communication system according to claim 12, further comprising a battery module for outputting a second power to the wireless communication module.

19. The wireless communication system according to claim 18, further comprising a detecting module electrically connected to the first solar module and the wireless communication module for detecting an electric capacity of the first solar module and transmitting the electric capacity to the wireless communication module.

20. The wireless communication system according to claim 19, wherein the wireless communication module comprises a switching unit electrically connected to the first solar module and the battery module, and switching to supply the second power outputted from the battery module to the wireless communication module when the detected electric capacity from the detecting module is smaller than a predefined value

21. The wireless communication system according to claim 12, further comprising a server electrically connected to the wireless communication device for transmitting or receiving the first wireless communication signal, wherein the server comprises a second solar power module for receiving the light and outputting a third power to the server according to the light.

22. The wireless communication system according to claim 12, further comprising a repeater electrically connected to the wireless communication device for transmitting or receiving the first wireless communication signal, wherein the repeater comprises a third solar power module for receiving a light and outputting a fourth power to the repeater.
